(19) United States
(12) Patent Application Publication
(10) Pub. No.: US 2012/0122324 A1
(43) Pub. Date: May 17, 2012

(54) CIRCUIT CONNECTION ASSEMBLY

(75) Inventors: Cheol-eun Jang, Suwon-si (KR); Sung-wook Choi, Changwon-si (KR); Woo-jong Cho, Suwon-si (KR); Soon-min Hong, Seoul (KR); Gyun Heo, Seoul (KR)

(73) Assignee: Samsung Electronics Co., Ltd., Suwon-si (KR)

(21) Appl. No.: 13/197,944

(22) Filed: Aug. 4, 2011

(30) Foreign Application Priority Data
Nov. 15, 2010 (KR) 10-2010-0113481

(51) Int. Cl. H01R 12/71

(52) U.S. Cl. 439/65

(57) ABSTRACT

A circuit connection structure is disclosed. A disclosed example circuit connection structure includes circuit board including a plurality of connection terminals; a housing for supporting the circuit board; and a circuit supporting unit including a plurality of circuit patterns on a surface thereof, formed of an electrical insulating material, and coupled to the housing so that the circuit patterns contact the connection terminals.

### CROSS-REFERENCE TO RELATED PATENT APPLICATION

This application claims the priority benefit of Korean Patent Application No. 10-2010-0113481, filed on Nov. 15, 2010, in the Korean Intellectual Property Office, the entirety of which is hereby incorporated by reference.

### BACKGROUND

1. Field of the Disclosure

This disclosure relates to a circuit connection structure, and more particularly, to a circuit connection structure in which an electrical connection state between electronic components is stably maintained.

2. Description of the Related Art

Various types of electronic components are installed in various types of digital apparatuses such as digital cameras, digital camcorders, mobile phones, or notebook computers. The electronic components may be connected to exchange electrical signals with each other via a cable or a connection terminal.

Additional space may be needed to dispose the cable or the connection terminal, and an assembling operation for electrically connecting the electronic components may be complicated. In addition, when the electronic components or other components of a digital apparatus are designed to be movable in order to perform various functions, the electrical connection between the electronic components or other components via the cable or the connection terminal may be impaired.

### SUMMARY

This application discloses circuit connection structures in which electrical connection states between electronic components are stably maintained.

This application also discloses a circuit connection structure that can be designed to have a compact size and to be easily assembled by electrically connecting electronic components without installing an additional component such as a cable or a connector.

According to an embodiment of this disclosure, there is provided a circuit connection structure including: a circuit board including a plurality of connection terminals; a housing supporting the circuit board; and a circuit supporting unit including a plurality of circuit patterns on a surface thereof, formed of an electrical insulating material, and coupled to the housing so that the circuit patterns contact the connection terminals.

The circuit supporting unit may include: a contacting portion contacting the connection terminals; and an elastically-deformable portion connected to the contacting portion, extending and being bent in a direction away from the circuit board, and being elastically deformable due to an applied force, wherein each of the circuit patterns may include a first pattern disposed on a surface facing the circuit board of the contacting portion, and a second pattern connected to the first pattern and disposed to extend up to the elastically-deformable portion.

The circuit connection structure may further include a frame of which one end contacts the elastically-deformable portion and is coupled to the housing so as to press the elastically-deformable portion toward the circuit board.

The circuit connection structure may further include an exposed terminal connected to the second pattern and disposed on the circuit supporting unit so as to face away from the circuit board.

The circuit connection structure may further include a connection unit formed of an electrical conductive material, and disposed between the connection terminals and the circuit patterns so as to electrically connect the connection terminals and the circuit patterns.

The connection unit is formed to protrude from the circuit pattern by coating at least a part of the circuit pattern of the circuit supporting unit with an electrical conductive material.

The connection unit is formed to protrude from the connection terminal by coating at least a part of by coating at least a part of the connection terminal of the circuit board with an electrical conductive material.

The circuit connection structure may further include a moving unit movably disposed with respect to the housing in an extension direction of the circuit patterns, wherein the moving unit may include a plurality contacting terminals protruding toward the circuit patterns from the moving unit so as to contact the circuit patterns of the circuit supporting unit.

Each of the contacting terminals may include a sliding contacting portion slidably moving along a surface of a corresponding circuit pattern when the contacting terminal contacts the circuit patterns.

The circuit connection structure may further include an elastic pressing unit of which one end is coupled to the moving unit and other end presses the sliding contacting portion toward a corresponding circuit pattern.

The circuit connection structure may further include an electronic component that is electrically connected to the circuit patterns and disposed on the circuit supporting unit.

The moving unit supports an optical element through which light passes.

The circuit connection structure may further include an optical element disposed in the housing and through which light passes, wherein the circuit board is disposed at the outer side of the optical element.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a perspective view illustrating a circuit connection structure, according to an embodiment of the present disclosure;

FIG. 2 is an exploded perspective view illustrating the circuit connection structure of FIG. 1;

FIG. 3 is an enlarged perspective view illustrating a part of the circuit connection structure of FIG. 2;

FIG. 4 is a bottom perspective view illustrating a bottom surface of the circuit connection structure of FIG. 2;

FIG. 5 is a cross-sectional side view illustrating a circuit connection structure, according to another embodiment of the present disclosure;

FIG. 6 is a cross-sectional side view illustrating a circuit connection structure, according to another embodiment of the present disclosure;

FIG. 7 is a rear view illustrating the circuit connection structure of FIG. 6;

FIG. 8 is a cross-sectional side view illustrating a circuit connection structure, according to another embodiment of the present disclosure; and

FIG. 9 is a perspective view illustrating a circuit connection structure, according to another embodiment of the present disclosure.

### DETAILED DESCRIPTION

Exemplary embodiments according to the present disclosure will be described in detail with reference to the accompanying drawings.

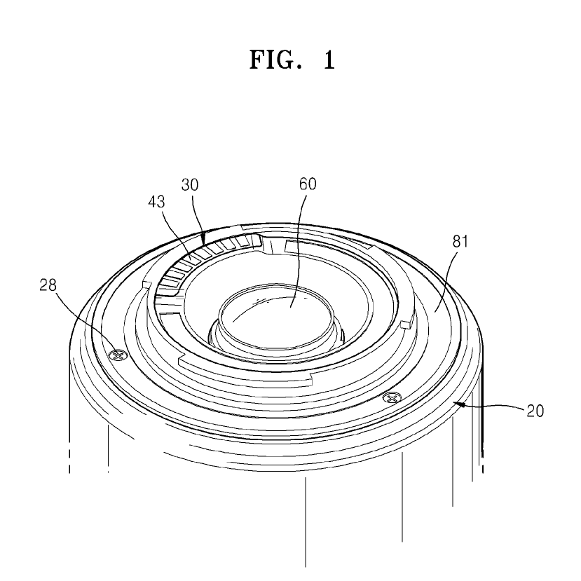

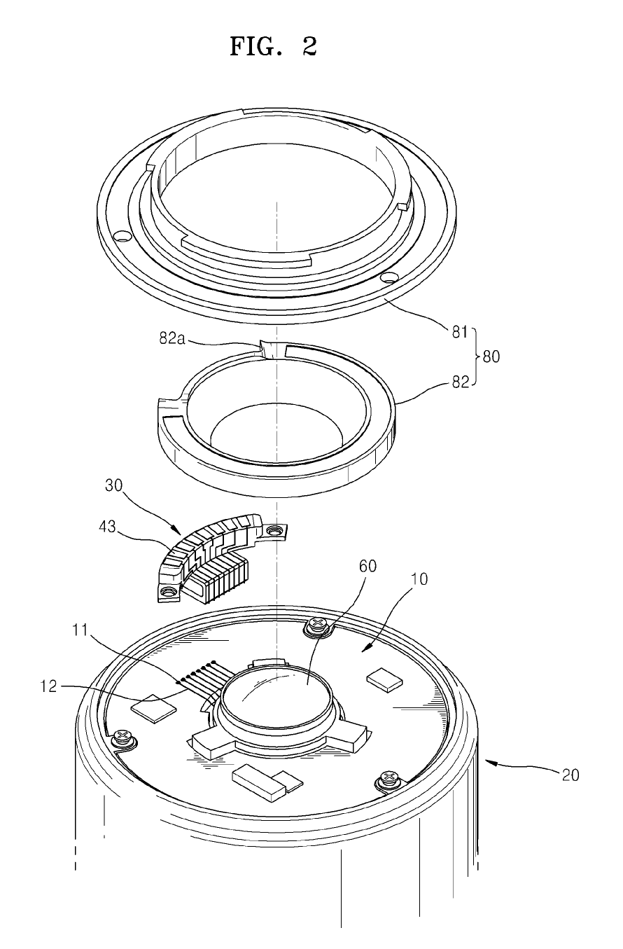

FIG. 1 is a perspective view illustrating a circuit connection structure, according to an embodiment of the present disclosure. FIG. 2 is an exploded perspective view illustrating the circuit connection structure of FIG. 1.

The circuit connection structure illustrated in FIGS. 1 and 2 is used in a lens barrel that is a detachably connected to a camera.

In general, in a single-lens reflex camera, a lens barrel is designed to be detachable from a camera body. When the camera body and the lens barrel are combined with each other, power necessary for operating the lens barrel is supplied to the camera via an interface module included in the camera body, and at the same time, the camera body and the lens barrel exchange one or more signals with each other. The circuit connection structure functions to transmit the signal(s) between the camera body and the lens barrel.

The circuit connection structure includes a circuit board 10, a housing 20 for supporting the circuit board 10, and a circuit supporting unit 30 coupled to the housing 20 so as to contact the circuit board 10.

The circuit board 10 may be a hard printed circuit board or a flexible printed circuit board, and is coupled to the housing 20. The circuit board 10 includes a plurality of circuits 12 for driving the lens barrel. Each of a plurality of connection terminals 11 is formed in each of the circuits 12.

The housing 20 may be formed of plastic and/or a metal coated with an insulating material. The housing 20 surrounds and supports various components of the lens barrel and components of the circuit connection structure.

A lens 60, which is an optical element through which light passes, is disposed in the housing 20. The circuit board 10 is disposed to surround at least a part of an edge of the lens 60 at the outer side of the lens 60.

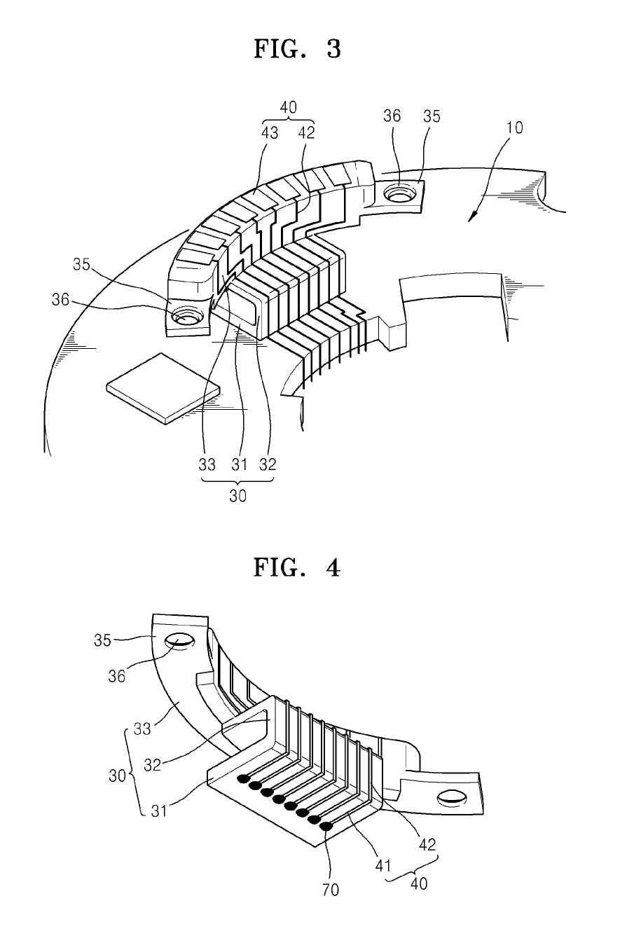

The circuit supporting unit 30 may be manufactured by injection molding by using an electrical insulating material such as rubber or plastic. The circuit supporting unit 30 includes a plurality of circuit patterns 40 (FIG. 3) on a surface thereof, and may be coupled to the housing 20 so as to contact the connection terminals 11 of the circuit board 10.

FIG. 3 is an enlarged perspective view illustrating a part of the circuit connection structure of FIG. 2. FIG. 4 is a bottom perspective view illustrating a bottom surface of the circuit connection structure of FIG. 2.

The circuit patterns 40 may be formed on the surface of the circuit supporting unit 30 by a molded interconnection device (MID) technology. The circuit patterns 40 are formed by directly plating a surface of an injection molded portion manufactured by using the MID technology with an electrical conductive material such as copper or nickel or printing the surface of the injection molded portion.

The MID technology may be used to make an electronic apparatus small and light by forming a three-dimensional circuit pattern on the injection molded portion, in order to increase a degree of freedom in designing a circuit and to mount the circuit pattern with high density.

The circuit supporting unit 30 includes a contacting portion 31 contacting the connection terminals 11 of the circuit board 10, an elastically-deformable portion 32 connected to the contacting portion 31, extending and being bent in a direction away from the circuit board 10, and being elastically deformable due to a force applied from the outside, and a terminal-disposed portion 33 connected to the elastically-deformable portion 32 and supporting a plurality of exposed terminals 43.

Each of the circuit patterns 40 formed on the circuit supporting unit 30 includes a first pattern 41 disposed on a surface facing the circuit board 10 of the contacting portion 31, a second pattern 42 connected to the first pattern 41 and disposed to extend up to the elastically-deformable portion 32, and the exposed terminal 43 connected to the second pattern 42 and disposed in the terminal-disposed portion 33 so as to face an opposite side of the circuit board 10.

The exposed terminals 43 are electrically connected to another circuit structure such as, for example, to the camera body (not shown). The first patterns 41 are electrically connected to the respective connection terminals 11. The second patterns 42 extend along the circuit supporting unit 30 and electrically connect the first patterns 41 and the exposed terminals 43.

In order to electrically connect the connection terminals 11 of the circuit board 10 and the first patterns 41 of the circuit patterns 40, a plurality of connection units 70 formed of an electrical conductive material may be disposed between the connection terminals 11 and the first pattern 41. In FIG. 4, the connection units 70 each may be formed to protrude from the first pattern 41 by coating a part of the first pattern 41 of the circuit supporting unit 30 with an electrical conductive material, such as for example, solder.

The circuit supporting unit 30 may be coupled to the housing 20 by a frame 80. When the frame 80 is coupled to the housing 20, one end of the frame 80 contacts the elastically-deformable portion 32 of the circuit supporting unit 30 and presses the elastically-deformable portion 32 toward the circuit board 10.

The frame 80 includes a groove 82a engaged with wing units 35 respectively formed at both edges of the circuit supporting unit 30, a pressing ring 82 disposed at an edge of the lens 60 of the lens barrel so as to contact the circuit board 10, and a flange 81 coupled to the housing 20 so as to press an outer side of the pressing ring 82 toward the circuit board 10.

As illustrated in FIG. 1, the flange 81 is coupled to the housing 20 via bolts 28. When the pressing ring 82, the circuit supporting unit 30, and the flange 81 are coupled to the housing 20, the exposed terminals 43 of the circuit supporting unit 30 are disposed at the edge of the lens 60.

The pressing ring 82 is coupled to the wing unit 35 of the circuit supporting unit 30 by using a coupling member, such as a bolt (not shown) or a rivet (not shown), passing through a through holes 36 formed in the wing units 35 of the circuit supporting unit 30. When the flange 81 is coupled to the housing 20, the pressing ring 82 is pressed by the flange 81 toward the circuit board 10, and thus the elastically-deformable portion 32 of the circuit supporting unit 30 is pressed by the pressing ring 82 toward the circuit board 10. Thus, contact between the first patterns 41 of the circuit patterns 40 and the connection terminals 11 may be stably maintained.

Also, the circuit supporting unit 30 and the circuit board 10 may be electrically and simply connected to each other by using the above-described circuit connection structure without using an additional component such as a flexible cable or a connector.

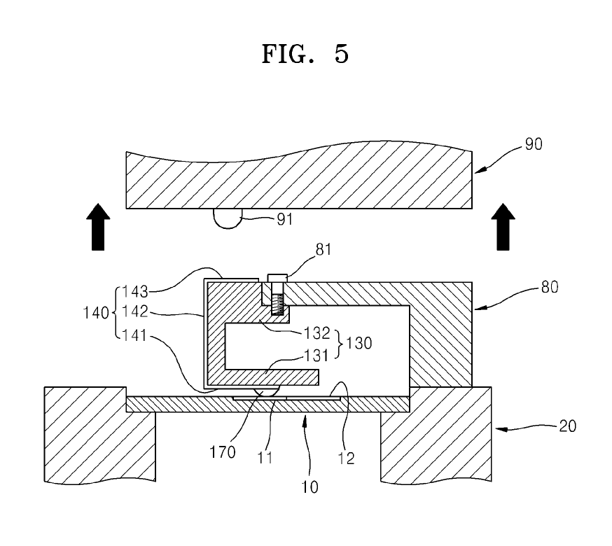

FIG. 5 is a cross-sectional side view illustrating a circuit connection structure, according to another embodiment of the present disclosure.

The circuit connection structure of the embodiment illustrated in FIG. 5 generally has a structure similar to the circuit connection structure illustrated in FIGS. 1 through 4. Hereinafter, like reference numerals designate like elements throughout the specification.

The circuit connection structure of FIG. 5 includes a circuit board 10 including a connection terminal 11, a housing 20 for supporting the circuit board 10, and a circuit supporting unit 130 coupled to the housing 20 so as to contact the circuit board 10.

The circuit board 10 includes a circuit 12, and the connection terminal 11 is formed in the circuit 12.

The circuit supporting unit 130 formed of an electrical insulating material includes a circuit pattern 140 on a surface thereof and may be coupled to the housing 20 so as to contact the connection terminal 11 of the circuit board 10.

The circuit supporting unit 130 includes a contacting portion 131 contacting the connection terminal 11 of the circuit board 10 and an elastically-deformable portion 132 connected to the contacting portion 131, extending and being bent in a direction away from the circuit board 10, and elastically deformable due to a force applied from the outside.

The circuit pattern 140 may be formed on a surface of the circuit supporting unit 130 by using an MID technology. The circuit pattern 140 includes a first pattern 141 disposed on a surface of the contacting portion 131 facing the circuit board 10, a second pattern 142 connected to the first pattern 141 and disposed to extend up to the elastically-deformable portion 132, and an exposed terminal 143 connected to the second pattern 142 and disposed on the elastically-deformable portion 132 so as to face an opposite side of the circuit board 10.

In order to electrically connect the connection terminal 11 of the circuit board 10 and the first pattern 141 of the circuit pattern 140, a connection unit 170 formed of an electrical conductive material may be disposed between the connection terminal 11 and the first pattern 141. In the current embodiment, the connection unit 170 may be formed to protrude from the connection terminal 11 by coating at least a part of the connection terminal 11 of the circuit board 10 with an electrical conductive material such as, for example, solder.

The circuit supporting unit 130 may be coupled to the housing 20 by a frame 80 coupled to the housing 20. Since one end of the frame 80 is coupled to the elastically-deformable portion 132 of the circuit supporting unit 130 via a bolt 81, the elastically-deformable portion 132 is pressed toward the circuit board 10. Thus, contact between the first pattern 141 of the circuit pattern 140 and the connection terminal 11 may be stably maintained.

The exposed terminal 143 is electrically connected to another circuit structure such as, for example, a connector 91 of a camera body 90. As described above, the circuit supporting unit 130 may be elastically deformed along a predetermined length toward the circuit board 10 by an operation of the elastically-deformable portion 132. Therefore, when the camera body 90 and the housing 20 are coupled to each other, the connector 91 of the camera body 90 contacts the exposed terminal 143, and thus, even when the connector 91 presses the circuit supporting unit 130, contact between the circuit pattern 140 and the connection terminal 11 of the circuit board 10 may be stably maintained.

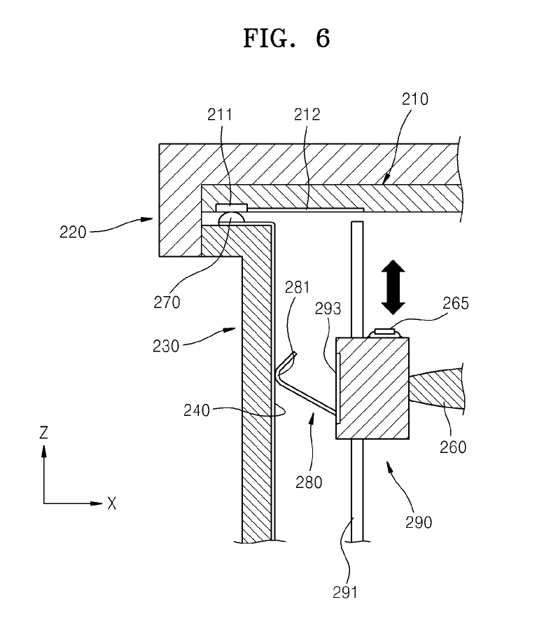

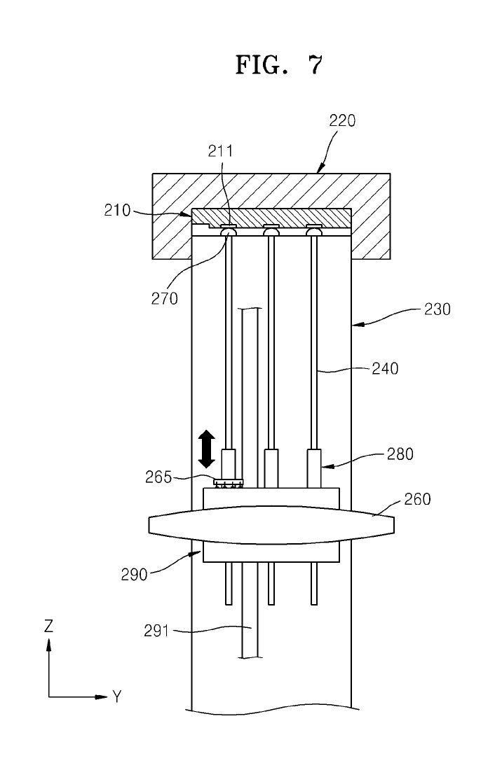

FIG. 6 is a cross-sectional side view illustrating a circuit connection structure, according to another embodiment of the present disclosure. FIG. 7 is a rear view illustrating the circuit connection structure of FIG. 6.

The circuit connection structure of the embodiment illustrated in FIGS. 6 and 7 includes a circuit board 210 including a circuit 212 and a connection terminal 211, a housing 220 for supporting the circuit board 210, a circuit supporting unit 230 coupled to the housing 220 so as to contact the circuit board 210, and a moving unit 290 movably disposed with respect to the housing 220.

The circuit supporting unit 230 formed of an insulating material includes a circuit pattern 240 formed by using a MID technology on a surface thereof and may be coupled to the housing 220 so as to contact the connection terminal 211 of the circuit board 210.

A connection unit 270 is disposed between the connection terminal 211 and the circuit pattern 240. The connection unit 270 may be formed to protrude from the circuit pattern 240 by coating at least a part of the circuit pattern 240 of the circuit supporting unit 230 with an electrical conductive material such as, for example, solder.

The moving unit 290 is slidably disposed along a rail 291. The rail 291 extends in a direction in which the circuit pattern 240 extends along the circuit supporting unit 230, that is, in an up-down or Z direction in FIG. 6. Accordingly, the moving unit 290 may move in an extension direction of the circuit pattern 240. In FIG. 6, the rail 291 is fixedly disposed with respect to the housing 220, but a structure for supporting the rail 291 is not shown in FIG. 6 for convenience.

The moving unit 290 may support an optical element for passing light. The optical element may be, for example, a structure for supporting a lens 260 of a camera and moving in an optical axis direction in order to perform auto-focusing or zooming. The moving unit 290 may include a circuit 265 and a connecting terminal 293 that is connected to the circuit 265 to exchange an electrical signal with the outside.

The moving unit 290 includes a contacting terminal 280 of which one end is electrically connected to the connecting terminal 293. The other end of the contacting terminal 280 includes a sliding contacting portion 281 contacting a surface of the circuit pattern 240. The sliding contacting portion 281 is bent at a portion where the sliding contacting portion 281 contacts the circuit pattern 240. Thus, as the moving unit 290 moves along the moving unit 290, the sliding contacting portion 281 slidably moves along a surface of the circuit pattern 240.

An electrical connection between the moving unit 290 and the circuit pattern 240 that move relatively with respect to each other may be stably maintained by using the above-described circuit connection structure without using an additional component such as a flexible cable or a connector. Also, in a conventional method using a flexible cable, the length of the flexible cable may be limited, and there is need to secure a space to move the flexible cable. However, in the above-described circuit connection structure, such limitations do not occur, and thus, degrees of freedom in designing a circuit may be increased.

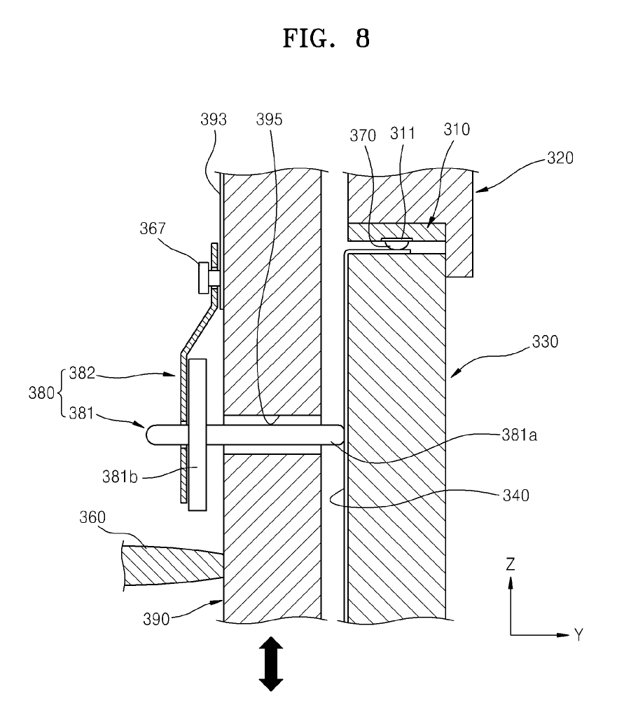

FIG. 8 is a cross-sectional side view illustrating a circuit connection structure, according to another embodiment of the present disclosure.

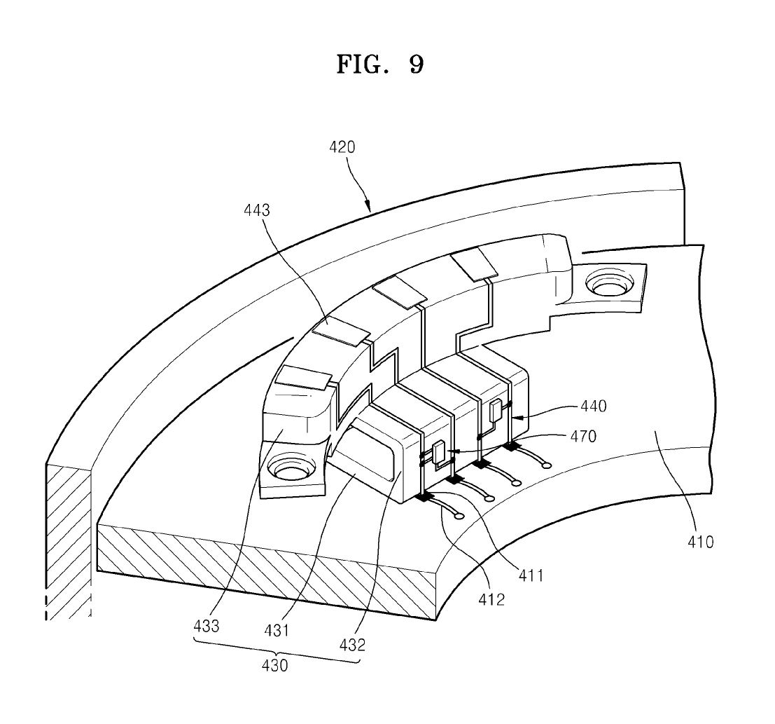

The circuit connection structure of the embodiment illustrated in FIG. 8 has a structure similar to a circuit connection structure illustrated in FIG. 9, but a contacting terminal 380 of a moving unit 390 has a different configuration from that of FIG. 9.

The circuit connection structure of FIG. 8 includes a circuit board 310 including a connection terminal 311, a housing 320 for supporting the circuit board 310, a circuit supporting unit 330 coupled to the housing 320 so as to contact the circuit board 310, and a moving unit 390 movably disposed with respect to the housing 320.

The circuit supporting unit 330 formed of an insulating material includes a circuit pattern 340 formed by using a MID technology on a surface thereof and may be coupled to the housing 320 so as to contact the connection terminal 311 of the circuit board 310.

A connection unit 370 is disposed between the connection terminal 311 of the circuit board 310 and the circuit pattern 340. The connection unit 370 may be formed to protrude from the circuit board 310 by coating at least a part of the connection terminal 311 of the circuit board 310 with an electrical conductive material such as, for example, solder.

The moving unit 390 may move in an extension direction of the circuit pattern 340, that is, in an up-down or Z direction in FIG. 8. In FIG. 8, a component such as a rail for movably supporting the moving unit 390 is not shown for convenience.

The moving unit 390 may support an optical element for passing through light. The moving unit 390 may be a structure for supporting, for example, a lens 360 of a camera and moving in an optical axis direction in order to perform auto-focusing or zooming. The moving unit 390 may include a circuit (not shown) and a connecting terminal 393 that is connected to the circuit to exchange an electrical signal with the outside.

The moving unit 390 includes a contacting terminal 380 protruding toward the circuit pattern 340 so as to contact the circuit pattern 340 of the circuit supporting unit 330. The contacting terminal 380 includes a sliding contacting portion 381 passing through a through hole 395 of the moving unit 390 and protruding so as to contact a surface of the circuit pattern 340, and an elastic pressing unit 382 pressing the sliding contacting portion 381 toward the circuit pattern 340.

One end of the sliding contacting portion 381 contacts a surface of the circuit pattern 340 and may slidably move along the surface of the circuit pattern 340. One end of the elastic pressing unit 382 is coupled to the moving unit 390 via a bolt 367. The other end of the elastic pressing unit 382 presses the other end 381b of the sliding contacting portion 381 toward the circuit pattern 340. Since the one end of the elastic pressing unit 382 is electrically connected to the connecting terminal 393 of the moving unit 390, the circuit pattern 340 is electrically connected to the connecting terminal 393 via the sliding contacting portion 381 and the elastic pressing unit 382.

FIG. 9 is a perspective view illustrating a circuit connection structure, according to another embodiment of the present disclosure.

The circuit connection structure of the embodiment illustrated in FIG. 9 includes a circuit board 410 including a plurality of connection terminals 411, a housing 420 for supporting the circuit board 410, a circuit supporting unit 430 including a plurality of circuit patterns 440 and coupled to the housing 420 so as to contact the circuit board 410, and electronic components 470 disposed on the circuit supporting unit 430 so as to be electrically connected to the circuit patterns 440.

The circuit supporting unit 430 includes a contacting portion 431 contacting the connection terminals 411 of the circuit board 410, an elastically-deformable portion 432 connected to the contacting portion 431, extending and being bent in a direction away from the circuit board 410, and elastically deformable due to force applied from the outside, and a terminal-disposed portion 433 connected to the elastically-deformable portion 432 and supporting a plurality of exposed terminals 443.

The circuit board 410 includes a plurality of circuits 412 each in which the connection terminal 411 is formed. As described above, the circuit patterns 440 is disposed on the circuit supporting unit 430 so as to extend along the contacting portion 431, the elastically-deformable portion 432, and the terminal-disposed portion 433. One end of the circuit pattern 440 is electrically connected to the connection terminal 411. The exposed terminals 443 of the circuit patterns 440 are electrically connected to another circuit structure such as, for example, a camera body (not shown).

The electronic components 470, such as passive elements or active elements, are electrically connected to the circuit patterns 440, and thus, the circuit patterns 440 of the circuit supporting unit 430 may not only be connected to the other circuit structure and the circuit board 410 but also perform signal processing.

In the above-described circuit connection structures, a circuit board and a circuit supporting unit are coupled to a housing so that a circuit pattern of the circuit supporting unit and a connection terminal of the circuit board, and thus, an electrical connection between the circuit pattern and the connection terminal may be stably maintained.

Also, the circuit supporting unit and the circuit board may be electrically and simply connected to each other by using the above-described circuit connection structure without using an additional component such as a flexible cable or a connector, and thus, an electronic apparatus may be designed to have a compact size.

The devices described herein may comprise a processor, a memory for storing program data and executing it, a permanent storage such as a disk drive, a communications port for handling communications with external devices, and user interface devices, including a touch panel, keys, buttons, etc. When software modules or algorithms are involved, these software modules may be stored as program instructions or computer readable codes executable on the processor on a computer-readable medium. Examples of the computer readable recording medium include magnetic storage media (e.g., ROM, floppy disks, hard disks, etc.), and optical recording media (e.g., CD-ROMs, or DVDs). The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of this disclosure, reference has been made to exemplary embodiments illustrated in the drawings, and specific terminology has been used to describe these embodiments. However, no limitation of the scope of this disclosure is intended by this specific terminology, and this disclosure should be construed to encompass all embodiments that would normally occur to one of ordinary skill in the art.

The present disclosure may be described in terms of functional block components and various processing steps. Such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, where the elements of the present disclosure are implemented using software programming or software elements the disclosed embodiments may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present disclosure could employ any number of conventional techniques for electronics configuration, signal processing and/or control, data processing and the like. The words “mechanism”, “element”, “means”, and “configuration” are used broadly and are not limited to mechanical or physical embodiments, but can include software routines in conjunction with processors, etc.

The particular implementations shown and described herein are illustrative examples and are not intended to otherwise limit the scope of this disclosure in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the disclosed embodiments unless the element is specifically described as “essential” or “critical”.

The use of the terms “a” and “an” and “the” and similar referents in the context of describing the disclosed embodiments (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The present disclosure is not limited to the described order of the steps. The use of any and all examples, or exemplary language (e.g., “such as”) provided herein, is intended merely to better illuminate the claimed inventions and does not pose a limitation on the scope of the claimed inventions unless otherwise claimed. Numerous modifications and adaptations will be readily apparent to those skilled in this art without departing from the spirit and scope of the present disclosure.

What is claimed is:

1. A circuit connection structure comprising:
a circuit board comprising a plurality of connection terminals;
a housing supporting the circuit board; and
a circuit supporting unit comprising a plurality of circuit patterns on a surface thereof, formed of an electrical insulating material, and coupled to the housing so that the circuit patterns contact the connection terminals.

2. The circuit connection structure of claim 1, wherein the circuit supporting unit comprises:
a contacting portion contacting the connection terminals; and
an elastically-deformable portion connected to the contacting portion, extending and being bent in a direction away from the circuit board, and being elastically deformable due to an applied force, wherein each of the circuit patterns comprises a first pattern disposed on a surface facing the circuit board of the contacting portion, and a second pattern connected to the first pattern and disposed to extend up to the elastically-deformable portion.

3. The circuit connection structure of claim 2, further comprising a frame of which one end contacts the elastically-deformable portion and is coupled to the housing so as to press the elastically-deformable portion toward the circuit board.

4. The circuit connection structure of claim 2, further comprising an exposed terminal connected to the second pattern and disposed in the circuit supporting unit so as to face away from the circuit board.

5. The circuit connection structure of claim 4, further comprising a connection unit formed of an electrical conductive material, and disposed between the connection terminals and the circuit patterns so as to electrically connect the connection terminals and the circuit patterns.

6. The circuit connection structure of claim 5, wherein the connection unit is formed to protrude from the circuit pattern by coating at least a part of the circuit pattern of the circuit supporting unit with an electrical conductive material.

7. The circuit connection structure of claim 5, wherein the connection unit is formed to protrude from the connection terminal by coating at least a part of the connection terminal of the circuit board with an electrical conductive material.

8. The circuit connection structure of claim 1, further comprising a moving unit movably disposed with respect to the housing in an extension direction of the circuit patterns, wherein the moving unit comprises a plurality of contacting terminals protruding toward the circuit patterns from the moving unit so as to contact the circuit patterns of the circuit supporting unit.

9. The circuit connection structure of claim 8, wherein each of the contacting terminals comprises a sliding contacting portion slidably moving along a surface of a corresponding circuit pattern when the contacting terminal contacts the circuit pattern.

10. The circuit connection structure of claim 9, further comprising an elastic pressing unit of which one end is coupled to the moving unit and other end presses the sliding contacting portion toward the circuit pattern.

11. The circuit connection structure of claim 8, wherein the moving unit supports an optical element through which light passes.

12. The circuit connection structure of claim 1, further comprising an electronic component that is electrically connected to the circuit patterns and disposed on the circuit supporting unit.

13. The circuit connection structure of claim 1, further comprising an optical element disposed in the housing and through which light passes, wherein the circuit board is disposed at the outer side of the optical element.
